(19) United States
(12) Patent Application Publication
(10) Pub. No.: US 2018/0150206 A1
(43) Pub. Date: May 31, 2018

(54) INFORMATION PROCESSING APPARATUS AND CONTROL METHOD THEREOF

(71) Applicant: CANON KABUSHIKI KAISHA, Tokyo (JP)

(72) Inventor: Ayumi Suzuki, Kawasaki-shi (JP)

(21) Appl. No.: 15/812,469

(22) Filed: Nov. 14, 2017

(30) Foreign Application Priority Data
Nov. 18, 2016 (JP) 2016-225097

(51) Int. Cl. G06F 3/0484; G06F 3/0483

(52) U.S. Cl. CPC G06F 3/04842; H04W 76/14; G06F 3/0483

(57) ABSTRACT

An information processing apparatus, including: a processor; and a memory storing a program which, when executed by the processor, causes the information processing apparatus to: issuer, in accordance with an active first application, an instruction to activate a second application; perform, in response to the instruction to activate the second application, a process of deactivating the first application and a process of activating the second application; control a display device to display a region for accepting an instruction to activate the first application if a predetermined period of time elapses after the second application becomes active; and perform, if the instruction to activate the first application is accepted, a process of activating the first application and a process of deactivating the second application.

### BACKGROUND OF THE INVENTION

### Field of the Invention

The present invention relates to an information processing apparatus, and a control method and a program thereof.

### Description of the Related Art

In recent years, digital cameras mounted with a wireless function such as a wireless LAN function have become more and more popular. There are applications for, in communication apparatuses such as a smartphone and information processing apparatuses, connecting to such a digital camera via a wireless LAN and acquiring images captured by the digital camera. In order to connect a digital camera and a smartphone to each other via a wireless LAN, an operation to cause the digital camera to participate in a network of the wireless LAN must be performed. In addition, an operation on the smartphone is required in order to set communication parameters such as an SSID or a password of the network on a setup screen of an operating system (OS). Furthermore, after the smartphone is connected to the network, an application for connecting to the digital camera must be started to establish a connection with the digital camera. As described above, connecting a digital camera and a smartphone to each other via a wireless LAN is problematic in that a large number of procedures are required.

In consideration thereof there are techniques for simplifying connection procedures by storing a communication parameter used when a connection had previously been established as history and using the stored communication parameter when subsequently establishing connections (for example, refer to Japanese Patent Application Laid-open No. 2013-162322). In addition, there are techniques for using a short-range wireless communication function such as near field communication (NFC) to share a communication parameter necessary for connection. According to these techniques, procedures for establishing an initial network connection can be simplified. However, establishing a connection using a short-range wireless communication function such as NFC is restricted in that devices must be brought close to each other (for example, refer to Japanese Patent Application Laid-open No. 2014-82587). Furthermore, there are also techniques which combine the conventional techniques described above to simplify procedures when establishing an initial network connections using a proximity wireless communication function and simplify procedures when establishing subsequent network connections using a stored parameter. In association with such techniques, there are techniques for more efficiently establishing a connection by appropriately managing information related to connections with previously connected devices (for example, refer to Japanese Parent Application Laid-open No. 2015-220677). Furthermore, there are also techniques for simplifying wireless LAN connection when connecting to a digital camera mounted with Bluetooth (registered trademark) by initially establishing communication with Bluetooth and subsequently switching to a wireless LAN connection.

### SUMMARY OF THE INVENTION

However, with conventional techniques, to start with, a user must have an understanding of wireless connection setup procedures of a digital camera, the existence of connection methods using NFC or Bluetooth, and whether or not a digital camera is mounted with NFC or Bluetooth. Although such information may be described in an instruction manual or the like of the digital camera, the information may not be read by the user or may be read but not sufficiently understood by the user due to the complexity of the procedures. In such cases, a problem arises in that the user is unable to use a wireless function provided in the digital camera.

An object of the present invention is to provide a technique for supporting a user so that procedures for wirelessly connecting a digital camera and a smartphone to each other can be reliably executed even when the user is not familiar with setup operations at the digital camera or the smartphone.

A first aspect of the present invention is an information processing apparatus, including:
a processor; and
a memory storing a program which, when executed by the processor, causes the information processing apparatus to:
issue, in accordance with an active first application, an instruction to activate a second application;
perform, in response to the instruction to activate the second application, a process of deactivating the first application and a process of activating the second application;
control a display device to display a region for accepting an instruction to activate the first application if a predetermined period of time elapses after the second application becomes active; and
perform, if the instruction to activate the first application is accepted, a process of activating the first application and a process of deactivating the second application.

A second aspect of the present invention is a control method of an information processing apparatus, the control method including:
issuing, in accordance with an active first application, an instruction to activate a second application;
performing, in response to the instruction to activate the second application, a process of deactivating the first application and a process of activating the second application;
controlling a display device to display a region for accepting an instruction to activate the first application if a predetermined period of time elapses after the second application becomes active; and
performing, if the instruction to activate the first application is accepted, a process of activating the first application and a process of deactivating the second application.

A third aspect of the present invention is a non-transitory computer-readable storage medium in which a program is recorded, the program causing a computer to execute:
issuing, in accordance with an active first application, an instruction to activate a second application;
performing, in response to the instruction to activate the second application, a process of deactivating the first application and a process of activating the second application;
controlling a display device to display a region for accepting an instruction to activate the first application if a predetermined period of time elapses after the second application becomes active; and
performing, if the instruction to activate the first application is accepted, a process of activating the first application and a process of deactivating the second application.

According to the present invention, a user can be provided with support so that procedures for wirelessly connecting a digital camera and a smartphone to each other can be reliably executed even when the user is not familiar with setup operations of the digital camera or the smartphone.

Further features of the present invention will become apparent from the following description of exemplary embodiments with reference to the attached drawings.

### BRIEF DESCRIPTION OF THE DRAWINGS

FIG. 1 is a block diagram showing a configuration of a digital camera according to first and second embodiments;

FIG. 2 is a block diagram showing a configuration of a smartphone according to the first and second embodiments;

FIG. 3 is a flow chart showing processes of a smartphone according to the first embodiment;

FIGS. 4A to 4H are diagrams showing examples of a screen of a tutorial according to the first embodiment;

FIG. 5 is a flow chart showing processes of a smartphone according to the second embodiment; and

FIGS. 6A to 6F are diagrams showing examples of a screen of a tutorial according to the second embodiment.

### DESCRIPTION OF THE EMBODIMENTS

Hereinafter, embodiments of the present invention will be described in detail with reference to the accompanying drawings. It is to be understood that the embodiments described below merely represent means of realizing the present invention and may be appropriately corrected or modified in accordance with a configuration of an apparatus to which the present invention is applied as well as various conditions. In addition, the present invention may be implemented by appropriately combining the respective embodiments. In the following embodiments, an example will be described of supporting a user who executes procedures for connecting a smartphone that represents an example of the information processing apparatus according to the present invention to a wireless network constructed by a digital camera that represents an example of the second information processing apparatus having a wireless function according to the present invention.

Configuration of Digital Camera

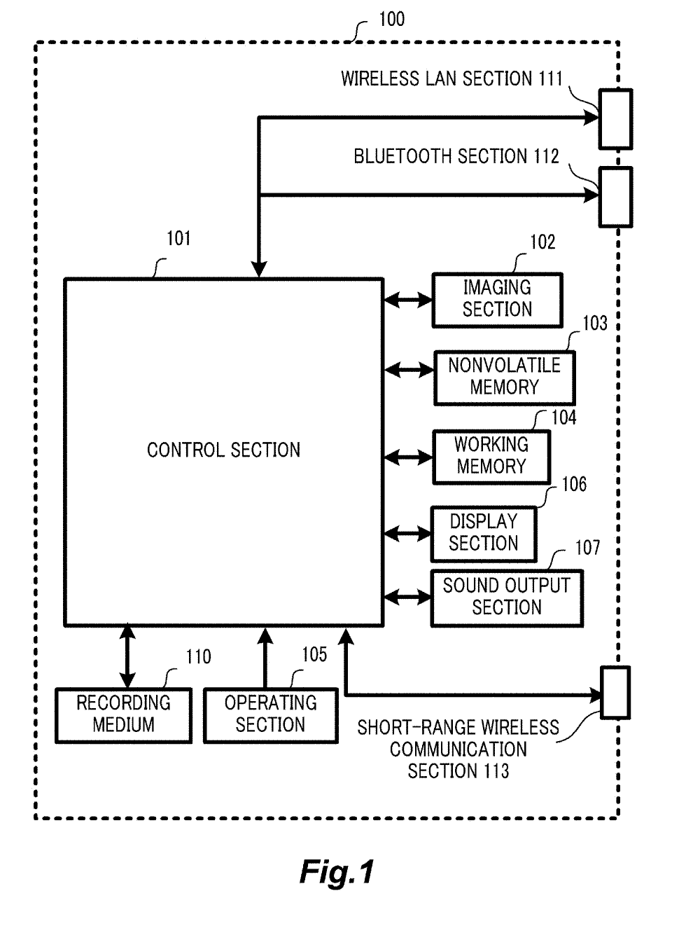

FIG. 1 is a block diagram showing a configuration example of a digital camera 100. While the digital camera 100 is an example of the second information processing apparatus as described above, the second information processing apparatus is not limited to a digital camera and may be an information processing apparatus such as a tablet device or a smartphone.

A control section 101 controls respective sections of the digital camera 100 in accordance with an input signal and a program (to be described later). Moreover, the control section 101 may be constituted by a single piece of hardware or may be constructed so that processing is shared by a plurality of pieces of hardware.

An imaging section 101 converts subject light focused by a lens included in the imaging section 102 into an electrical signal, performs a noise reduction process or the like, and outputs digital data as image data. The captured image data is stored in a buffer memory, subjected to a predetermined arithmetic operation in the control section 101, and subsequently recorded in a recording medium 110.

A nonvolatile memory 103 is an electrically erasable and recordable nonvolatile memory, and stores, for instance, a program (to be described later) to be executed by the control section 101.

A working memory 104 is used as a buffer memory for temporarily storing image data captured by the imaging section 102, an image display memory of a display section 106, a working area of the control section 101, and the like.

An operating section 105 is used in order to accept instructions by a user with respect to the digital camera 100. The operating section 105 includes, for example, a power supply button that enables the user to issue an instruction to turn on/off a power supply of the digital camera 100 and a release switch that enables the user to issue an instruction to capture an image. The operating section 105 further includes operating members such as a playback button for issuing an instruction to play back image data and a menu button for issuing an instruction to display a menu for performing wireless connection setup. In addition, a touch panel formed in the display section 106 (to be described later) is also included in the operating section 105. The release switch includes SW1 and SW2. SW1 is turned on when the release switch enters a so-called half-pressed state. Accordingly, instructions for performing imaging preparations such as an automatic focusing (AF) process, an automatic exposure (AE) process, an automatic white balance (AWB) process, and a preliminary light emission before flash (EF) process are accepted. Furthermore, SW2 is turned on when the release switch enters a so-called fully-pressed state. Accordingly, instructions for performing imaging are accepted.

The display section 106 displays a view finder image during imaging, displays captured image data, displays characters for interactive operations, displays setup screens, and the like. Moreover, the display section 106 need not necessarily be built into the digital camera 100. The digital camera 100 need only have a function for connecting to a built-in display section 106 or an external display section 106 connected by a cable or the like and for controlling display by the display section 106. Such a function can be made a component of, for example, the control section 101. The display section 106 may include a touch sensor that detects a touch operation by the user, and a touch panel that inputs an instruction based on a touch operation detected by the touch sensor to the digital camera 100 may be formed.

A sound output section 107 outputs sound during playback of a captured moving image, a shutter sound, a setup sound, and the like. The sound output section 107 need not necessarily be built into the digital camera 100. The digital camera 100 need only have a function for connecting to a built-in sound output section 107 or an external sound output section 107 connected by a cable or the like and for controlling the output of sound by the sound output section 107. Such a function can be made a component of, for example, the control section 101.

The recording medium 110 is capable of recording image data output from the imaging section 102. The recording medium 110 may be configured so as to be attachable to and detachable from the digital camera 100 or may be built into the digital camera 100. The digital camera 100 need only have means to at least access the recording medium 110.

A wireless LAN section 111 is an interface for connecting to an external apparatus by wireless communication and mutually exchanging information. Examples of communication performed by the wireless LAN section 111 include communication conforming to the IEEE 802.11 standard. The digital camera 100 is capable of connecting to a smartphone 200 with a wireless LAN via the wireless LAN section 111. The control section 101 realizes wireless communication with external apparatuses by controlling the wireless LAN section 111.

The digital camera 100 is capable of operating as a slave apparatus in an infrastructure mode. When operating as a slave apparatus, the digital camera 100 is capable of connecting to a nearby access point (hereinafter, AP) and participating in a network constructed by the AP. In addition, the digital camera 100 is also capable of operating as a simple AP. A simple AP is a type of AP that is simplified in terms of having limited functionality as compared to an ordinary AP. Moreover, an AP is an example of a relay apparatus. When the digital camera 100 operates as a simple AP, the digital camera 100 constructs a network by itself. Apparatuses around the digital camera 100 recognize the digital camera 100 as an AP and can participate in a network constructed by the digital camera 100. A program that enables the digital camera 100 to operate as described above is stored in the nonvolatile memory 103. However, the digital camera 100 that operates as a simple AP does not have a gateway function for transferring data received from a slave apparatus to an internet provider or the like. Therefore, even if the digital camera 100 receives data free other apparatuses participating in the constructed network, the digital camera 100 cannot transfer the data to a network such as the Internet.

A Bluetooth section 112 is a communication interface between the digital camera 100 and external apparatuses and includes an antenna, a modulation/demodulation circuit, a communication controller, and the like. The Bluetooth section 112 has lower power consumption than the wireless LAN section 111, and performs wireless communication with a short communication range and a low communication speed with external devices. For example, it is assumed that the Bluetooth section 112 performs communication conforming to the low energy (BLE) standard according to Bluetooth version 4.0 or later. Communication by the Bluetooth section 112 with external devices is executed under control of the control section 101. Moreover, the digital camera 100 may include a functional section that performs communication conforming to other wireless communication standards in place of or in addition to the wireless LAN section 111 and the Bluetooth section 112.

A short-range wireless communication section 113 performs contactless proximity wireless communication with other devices. The short-range wireless communication section 113 is constituted by, for example, an antenna section for wireless communication and a modulation/demodulation circuit for processing a wireless signal. The short-range wireless communication section 113 realizes contactless short-range wireless communication by outputting a modulated wireless signal from an antenna and demodulating a wireless signal received by the antenna. The communication standard is, for example, contactless short-range wireless communication conforming to the ISO/IEC 18092 standard (so-called NFC: Near Field Communication). When the short-range wireless communication section 113 establishes communication and subsequently receives a data read request from another device, the short-range wireless communication section 113 output data based on data stored in the nonvolatile memory 103. Moreover, the contactless proximity communication realized by the short-range wireless communication section 113 is not limited to NFC and other wireless communication may be adopted. For example, as the contactless proximity communication realized by the short-range wireless communication section 113, contactless proximity communication conforming to the ISO/IEC 14443 standard may be adopted.

This concludes the description of the digital camera 100.

Configuration of Smartphone

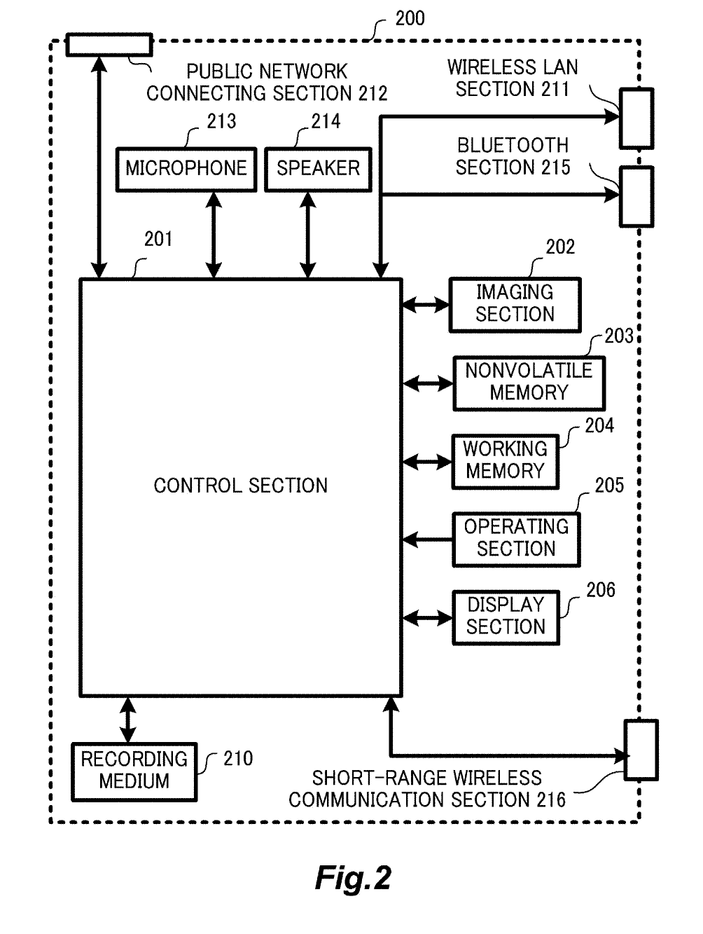

FIG. 2 is a block diagram showing a configuration example of the smartphone 200. While the smartphone 200 is an example of the information processing apparatus as described above, the information processing apparatus is not limited to a smartphone and may be an information processing apparatus such as a digital camera with a wireless function, a portable media player, a tablet device, or a personal computer.

A control section 201 controls respective sections of the smartphone 200 in accordance with an input signal and a program (to be described later). Moreover, the control section 201 may be constituted by a single piece of hardware or may be constructed so that processing is shared by a plurality of pieces of hardware.

An imaging section 202 converts subject light focused by a lens included in the imaging section 202 into an electrical signal, performs a noise reduction process or the like, and outputs digital data as image data. The captured image data is stored in a buffer memory, subjected to a predetermined arithmetic operation in the control section 201, and subsequently recorded in a recording medium 210.

A nonvolatile memory 203 is an electrically erasable and recordable nonvolatile memory, and stores, for instance, various programs to be executed by the control section 201. A program for communicating with the digital camera 100 is also stored in the nonvolatile memory 203. The program is installed in the smartphone 200 as a camera communication application. Processes of the smartphone 200 to be described later are realized by loading a program provided by the camera communication application. Moreover, it is assumed that the camera communication application includes a program for using basic functions of an OS installed in the smartphone 200. Alternatively, the OS of the smartphone 200 may include a program for realizing processes according to the present invention.

A working memory 204 is used as a buffer memory for temporarily storing image data generated by the imaging section 202, an image display memory of a display section 206, a working area of the control section 201, and the like.

An operating section 205 is used in order to accept instructions by a user with respect to the smartphone 100. The operating section 205 includes, for example, a power supply button that enables the user to issue an instruction to turn on/off a power supply of the smartphone 200 and operating members such as a touch panel formed on the display section 206.

The display section 206 displays image data, characters for interactive operations, and the like. Moreover, the display section 206 need not necessarily be built into the smartphone 200. The smartphone 200 need only have a function for connecting to a built-in display section 206 or an external display section 206 connected by a cable or the like and controlling display by the display section 206. Such a function can be made a component of, for example, the control section 201.

The recording medium 210 is capable of recording image data output from the imaging section 202. The recording medium 210 may be configured so as to be attachable to and detachable from the smartphone 200 or may be built into the smartphone 200. The smartphone 200 need only have means to at least access the recording medium 210.

A wireless LAN section 211 is an interface for connecting to an external apparatus by wireless communication and mutually exchanging information. The control section 201 realizes wireless communication with external apparatuses by controlling the wireless LAN section 211. Moreover, the smartphone 200 is capable of at least operating as a slave apparatus in an infrastructure mode of a wireless LAN and participating in a network constructed by a nearby AP.

A public network connecting section 212 is an interface used when performing public wireless communication. The smartphone 200 is capable of calling or performing data communication with other devices via the public network connecting section 212. When calling, the control section 201 inputs and outputs sound signals via a microphone 213 and a speaker 214. The public network connecting section 212 includes an interface for performing communication using 3G. Alternatively, a configuration which communicates using a communication system other than 3G such as LTE, WiMAX, ADSL, FTTH, and so-called 4G may be adopted. In addition, the wireless LAN section 211 and the public network connecting section 212 need not necessarily be constituted by independent hardware and may be configured so as to share, for example, a single antenna.

A Bluetooth section 215 is a communication interface between the smartphone 200 and external apparatuses and includes an antenna, a modulation/demodulation circuit, a communication controller, and the like. The Bluetooth section 215 has lower power consumption than the wireless LAN section 211, and performs wireless communication with a short communication range and a low communication speed with external devices. For example, the Bluetooth section 215 performs communication conforming to the BLE standard in a similar manner to the Bluetooth section 112 of the digital camera 100. The control section 201 realizes wireless communication with external apparatuses by controlling the Bluetooth section 215. Moreover, the smartphone 200 may include a functional section that performs communication conforming to other wireless communication standards in place of or in addition to the wireless LAN section 211 and the Bluetooth section 215.

A short-range wireless communication section 216 performs contactless proximity wireless communication with other devices. The short-range wireless communication section 216 is constituted by, for example, an antenna for wireless communication, a modulation/demodulation circuit for processing a wireless signal, and a communication controller. The short-range wireless communication section 216 realizes contactless proximity communication by outputting a modulated wireless signal from the antenna and demodulating a wireless signal received by the antenna. The communication standard is, for example, contactless proximity communication conforming to the ISO/IEC 18092 standard (so-called NFC: Near Field Communication). The short-range wireless communication section 216 operates in a card reader mode, a card writer mode, and a P2P mode as defined in the NFC standard.

This concludes the description of the smartphone 200.

Next, a wireless LAN connection between the digital camera 100 and the smartphone 200 now will be described.

The digital camera 100 and the smartphone 200 are wirelessly connected to each other via the wireless LAN section 111 and the wireless LAM section 211 and perform two-way communication. Specifically, the digital camera 100 operates as a simple AP and constructs a wireless LAN network. When operating as a simple AP, the digital camera 100 starts periodically transmitting beacon signals. The smartphone 200 detects a beacon signal and participates in the wireless LAN network constructed by the digital camera 100. Subsequently, due to the camera communication application running on the smartphone 200, the devices find each other and after acquisition of capability information of the devices, communication between the devices is established to enable data to be transmitted and received via the wireless LAN.

Moreover, the connection between the digital camera 100 and the smartphone 200 can be realized by methods that do not involve the digital camera 100 becoming an AP. For example, a configuration may be adopted in which the digital camera 100 and the smartphone 200 participate in a wireless LAN network constructed by an external AP and the digital camera 100 and the smartphone 200 communicate with each other in the wireless LAN network.

Once communication between the digital camera 100 and the smartphone 200 is established as described above, after a predetermined exchange, the smartphone 200 becomes capable of acquiring images captured by the digital camera 100.

### FIRST EMBODIMENT

In a first embodiment, the smartphone 200 performs wireless communication with the digital camera 100 using a tutorial screen (hereinafter, a tutorial) which is displayed by a camera communication application running on the smartphone 200 and which guides a user through procedures for connecting the smartphone 200 to a wireless network. The camera communication application is an example of the first application according to the present invention and is an application which guides the user through procedures for connecting an information processing apparatus to a wireless network.

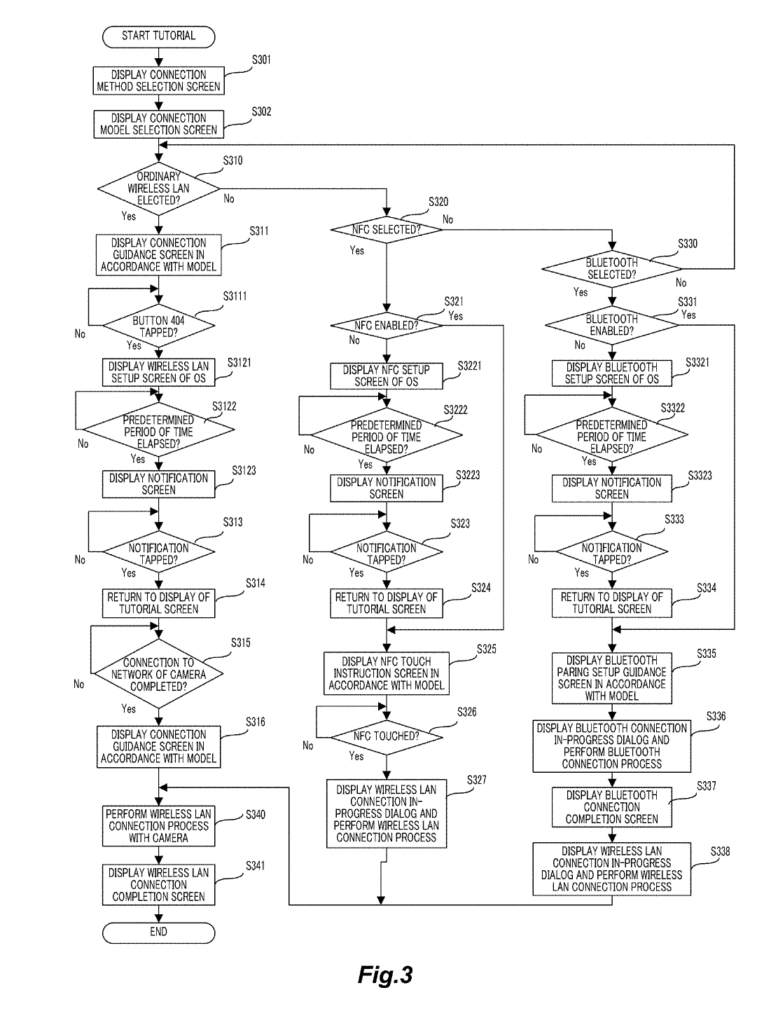

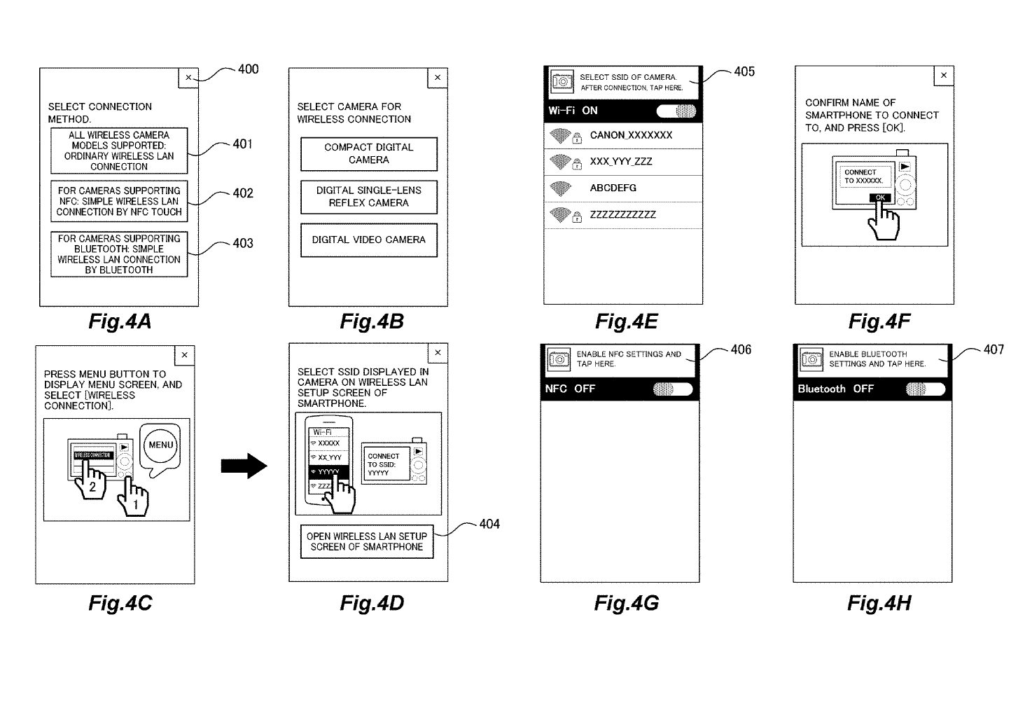

FIG. 3 is a flow chart showing processes of a screen transition in the tutorial. In addition, the process represented by the flow chart shown in FIG. 3 will be described in detail using examples of the respective screens in the screen transition of the tutorial shown in FIGS. 4A to 4H. Moreover, the processes described below are realized by the control section 201 of the smartphone 200 by controlling respective sections of the apparatus in accordance with a program stored in the nonvolatile memory 203. Therefore, the processes described as though being executed by an application in the following description may be considered being executed by the control section 201 in accordance with a program of the application.

When the camera communication application is started up by the user, a tutorial that guides the user through procedures for connecting the smartphone 200 to a wireless network is started.

First, in step S301, the camera communication application displays a connection method selection screen such as that shown in FIG. 4A. By tapping a button corresponding to a model of the digital camera 100 that the user wishes to connect to, the user inputs, to the smartphone 200, information regarding a wireless communication system supported by the digital camera 100 with which a wireless connection is to be established. For example, when the digital camera 100 supports NFC, the user can select a button 402 representing a wireless LAN connecting using NFC. When the digital camera 100 supports Bluetooth, the user can select a button 403 representing a wireless LAN connecting using Bluetooth. When participating in a wireless LAN network constructed by the digital camera 100, the user must input a communication parameter such as an SSID or a password on a setup screen related to wireless communication of the OS of the smartphone 200. However, when NFC or Bluetooth is available, since the smartphone 200 can acquire such information from the digital camera 100 via communication using NFC or Bluetooth, procedures necessary for wireless LAN connection can be simplified.

When the smartphone 200 does not support NFC or Bluetooth, on the screen shown in FIG. 4A, only buttons corresponding to communication systems supported by the smartphone 200 are displayed. In order to realize such processing, in the process of step S301, the camera communication application acquires information on whether or not the smartphone 200 supports NFC or Bluetooth from the OS. In addition, the screen shown in FIG. 4A is displayed by setting buttons corresponding to communication systems determined as being unsupported not to be displayed. In FIG. 4A, a button 400 is a button for closing the tutorial and returning to a top screen of the communication application.

In step S302, the camera communication application displays a screen for selecting a model of a camera with which a connection is to be established such as that shown in FIG. 4B. The camera communication application can generate this model selection screen using various methods. For example, a list of models and product names registered by the user in advance can be displayed, or data of various cameras having a wireless communication function can be stored in the nonvolatile memory 203 in advance and a list of models and product names read from the nonvolatile memory 203 can be displayed. In FIG. 4B, for the sake of brevity, an example displaying three candidates including a compact digital camera, a single-lens reflex camera, and a video camera is shown.

In step S310, the camera communication application determines whether or not the user has selected a button 401 representing an ordinary wireless LAN connection on the screen shown in FIG. 4A. When it is determined that the button 401 has been selected, the camera communication application proceeds to step S311.

In step S311, in accordance with the model selected on the screen shown in FIG. 4B, the camera communication application displays a guidance screen that guides the user through procedures for connecting the digital camera 100 and the smartphone 200 to each other by a wireless LAN connection. An example of the guidance screen is shown in FIG. 4C. FIG. 4C shows, as a guidance screen, images and characters which guide the user through operations for enabling the wireless function of the digital camera 100 and displaying information on a simple AP constructed by the digital camera 100 on the display section 106 of the digital camera 100. FIG. 4C represents an example of a guidance screen to a case where the compact digital camera is selected in FIG. 4B. In this case, the tutorial provided by the camera communication application is configured such that a migration (transition) between screens which provide guidance on respective procedures is realized by a swipe operation on a touch panel. Therefore, FIG. 4C only displays characters and images that describe operations and a close button and, by swiping the screen, a transition to a screen (FIG. 4D) for guiding the user through a next procedure can be made. However, the screen transition method in the tutorial is not limited to the above. For example, a graphical user interface (GUI) image (for example, a “next” button) for inputting an instruction to make a transition to a screen (FIG. 4D) for guiding the user through the next procedure can be displayed on one screen shown in FIG. 4C. In this case, when a touch operation on the “next” button is accepted, the camera communication application makes a transition to the next screen (FIG. 4D).

When the user performs an ordinary wireless LAN connection, a procedure is required in which an SSID of a network of which the digital camera 100 is a participant is selected and, if necessary, a password is input on the wireless LAN setup screen of the OS of the smartphone 200. An example of a screen displayed by the camera communication application in order to guide the user through this procedure is shown in FIG. 4D. In FIG. 4D, a button 404 for accepting an input of an instruction from the user to open the wireless LAN setup screen of the OS from the camera communication application is displayed. By tapping the button 404, the user can open the wireless LAN setup screen of the OS of the smartphone 200 from a tutorial screen displayed by the camera communication application. In other words, the smartphone 200 accepts an instruction to start the second application from the active first application from the user. The wireless LAN setup function of the OS is an example of the second application according to the present invention and is an application for performing settings related to wireless communication of an information processing apparatus.

In subsequent step S3111, the camera communication application stands by for an operation by the user of tapping the button 404. When the camera communication application determines that the user has performed an operation to tap the button 404, the camera communication application proceeds to step S3121.

In step S3121, the camera communication application causes the OS to start the wireless LAN setup function. Specifically, in response to the input of an instruction by the user to the camera communication application (the first application), the smartphone 200 starts and activates the second application (the wireless LAN setup function of the OS). Accordingly, a screen of the second application is displayed in the foreground and a screen of the first application is moved to the background and becomes hidden. In other words, when the second application becomes active, the first application becomes nonactive while maintaining a started state thereof.

After causing the OS to display the wireless LAN setup screen, the camera communication application measures elapsed time and determines whether the elapsed time has reached a predetermined period of time (for example, three seconds) (S3122). When the predetermined period of time elapses, a notification screen is displayed (S3123). An example of the screen at this point is shown in FIG. 4E. Specifically, the smartphone 200 displays the notification screen in a case where the predetermined period or time elapses after the second application becomes active. Accordingly, since a notification is displayed at a timing that differs from a timing at which the screen makes a transition from the camera communication application to the wireless LAN setup screen of the OS, a situation where it is difficult to recognize the notification display due to being obscured by display animation of a screen transition can be suppressed. Moreover, a similar effect can be produced when displaying the notification screen in a case where the predetermined period of time elapses after the first application becomes nonactive.

In this case, the notification refers to a function for displaying a notification screen including display of a massage by the first application and display for accepting input of an instruction to activate the first application from the user while maintaining an active state of the second application. This function may be a function mounted to the OS of the smartphone 200 or a function included in the first application.

The notification screen may be displayed in a display region of the smartphone 200 in a region where the second application is not displayed or may be displayed superimposed on the display of the second application in a part of a region where the second application is displayed. FIG. 4E illustrates a case where a notification screen 405 is displayed superimposed near an super title bar of the second application. The display method of the notification screen 405 is not limited thereto and, for example, a free region for displaying the notification screen 405 may be reserved in the display region of the smartphone 200 by temporarily moving the display of the second application in any of upward, downward, leftward, and rightward directions. Alternatively, a free region for displaying the notification screen 405 may be reserved in the display region of the smartphone 200 by temporarily reducing a size of the display of the second application.

Due to the notification function, even when the first application is not in the active state, a message can be displayed in a notification region and information can be presented to the user in a similar manner to the notification screen 405 shown in FIG. 4E. Alternatively, a configuration can be adopted in which, by constructing the notification region as a GUI that enables an instruction to be input to the smartphone 200 by a tap operation of the user, an instruction to restore the first application to an active state can be input by, for example, tapping the notification region.

Using this notification mechanism, a message from the camera communication application can be presented to the user even when the wireless LAN setup screen of the OS is being displayed. Specifically, due to the notification function, the camera communication application displays a message which guides the user through an operation to be performed on the wireless LAN setup screen of the OS and which supports wireless LAN setup by the user. In the example shown in FIG. 4E, a message prompting selection, as a connection destination, of an SSID of a network constructed by the digital camera 100 as a simple AP is displayed on the notification screen.

In addition, after selecting the wireless LAN network constructed by the digital camera 100 as a connection destination on the wireless LAN setup screen of the OS, a procedure for returning to the camera communication application and establishing a connection between the digital camera 100 and the smartphone 200 must be performed. The notification screen 405 shown in FIG. 4E is constructed as a GUI that enables an instruction to be input to the smartphone 200 by a tap operation of the user and enables an instruction to activate the camera communication application to be input by a tap operation. In the example shown in FIG. 4E, a message prompting the user to tap the notification region to return to the camera communication application is displayed in the notification region. Accordingly, after the user performs procedures for connecting to the network constructed by the digital camera 100 on the wireless LAN setup screen of the OS, the user can be supported to return to the camera communication application (the tutorial screen shown in FIG. 4D) and reliably proceed to a next procedure.

In step S313, the smartphone 200 determines whether or not a tap operation for instructing a return to the camera communication application has been performed on the notification screen 405, and when determining that a tap operation has been performed, the smartphone 200 proceeds to step S314.

In step S314, a return is made from the wireless LAN setup screen of the OS to the tutorial screen (FIG. 4D) of the camera communication application. In this manner, when an instruction to activate the first application (the camera communication application) is input on the notification screen 405, a return is made from the second application (the wireless LAN setup screen of the OS) to the first application (the camera communication application).

In step S315, the camera communication application determines whether or not the smartphone 200 has connected to the wireless LAN network constructed by the simple AP function of the digital camera 100. For example, the camera communication application determines whether or not there is a digital camera capable of communicating with the camera communication application on a wireless LAN network having been selected by a user operation on the wireless LAN setup screen of the OS shown in FIG. 4E and to which the smartphone 200 has actually connected. When such a digital camera is detected, the camera communication application determines that the smartphone 200 has completed connection to the wireless LAN network constructed by the digital camera 100, and proceeds to step S316.

In step S316, when there is a procedure necessary for wireless LAN connection in accordance with a model, the tutorial screen of the camera communication application which guides the user through the procedure is displayed. For example, there may be cases where, in the digital camera 100, a procedure is required to perform an operation of permitting connection with respect to a smartphone attempting to connect to the wireless LAN network constructed by the digital camera 100. In such a case, as a next procedure, a tutorial screen constituted by images and characters which prompt the user to perform an operation on the digital camera 100 to permit connection by the smartphone 200 is displayed. An example of such a tutorial screen is shown in FIG. 4F. The presence or absence of such an additional procedure differs for each model selected by the user in FIG. 4B. For each model, the camera communication application stores information on a procedure for connecting the smartphone to a simple AP and data of a tutorial screen to provide guidance to the user, and performs the display of FIG. 4F in accordance with the selection made in FIG. 4B. The camera communication application stands by for the user to perform a camera operation in accordance with contents of the tutorial.

In step S340, the smartphone 200 establishes a wireless LAN connection with the digital camera 100. Accordingly, communication of image data and the like by the camera communication application can be performed. Once a wireless LAN connection is established, in step S341, the camera communication application displays a completion screen of the tutorial.

In step S320, the camera communication application determines whether or not the user has selected a button 402 representing a wireless LAN connection using NFC on the screen shown in FIG. 4A. When it is determined that the button 402 has been selected, the camera communication application proceeds to step S321.

In step S321, the camera communication application determines whether or not NFC is enabled in the settings of the OS of the smartphone 200. The camera communication application proceeds to step S3221 when it is determined that NFC is disabled but proceeds to step S325 when it is determined that NFC is enabled.

In step S3221, the camera communication application causes the OS to display an NFC setup screen. After causing the OS to display the NFC setup screen, the camera communication application measures elapsed time and determines whether the elapsed time has reached a predetermined period of time (for example, three seconds) (S3222). When the predetermined period of time elapses, a notification screen is displayed (S3223). An example of the screen at this point is shown in FIG. 4G.

The camera communication application (the first application) determines whether or not to activate the NFC setup screen (the second application) of the OS based on a selection result of FIG. 4A (whether or not the NFC button 402 has been selected) and on a determination result of S321 (whether NFC is enabled or disabled). When the NFC button 402 has been selected in FIG. 4A and NFC is disabled in S321, the camera communication application (the first application) issues an instruction to start an NFC setup function (the second application) of the OS. In response to the instruction, the smartphone 200 starts and activates the NFC setup function (the second application) of the OS. In the case of S3121, the second application is started in response to a user instruction, but in the case of S3221, the second application is started in response to an instruction from the first application.

In step S323, the camera communication application determines whether or not a tap operation for instructing a return to the camera communication application has been performed on the notification screen 406, and when determining that a tap operation has been performed, the camera communication application proceeds to step S324.

In step S324, an instruction to return to the tutorial screen of the camera communication application from the NFC setup screen of the OS is input to the smartphone 200.

In step S325, a tutorial screen that guides the user through a procedure for NFC connection in accordance with the model selected on the screen shown in FIG. 4B is displayed. In step S325, for example, the camera communication application displays guidance reading “Bring digital camera and smartphone close to each other”. In this manner, when an instruction to activate the first application (the camera communication application) is input on the notification screen 406, a return is made from the second application (the NFC setup screen of the OS) to the first application (the camera communication application).

Moreover, if NFC is not enabled when the user performs a tap operation to instruct a return to the camera communication application in S323, the NFC setup screen shown in FIG. 4G may remain displayed without returning to the camera communication application. In addition, by displaying a message such as “Enable NFC” on the notification screen 406, support may be provided so that the user can reliably execute a procedure to enable NFC. In other words, a notification screen may be displayed which includes a message generated by the first application (the camera communication application) in accordance with an operation by the user with respect to the second application (the NFC setup screen) or a state of the smartphone 200 (NFC enabled or disabled).

In step S326, the smartphone 200 determines whether or not the user has performed an NFC touch operation between the digital camera 100 and the smartphone 200. When it is determined that an NFC touch operation has been performed, the smartphone 200 proceeds to step S327.

In step S327, the smartphone 200 displays a wireless LAN connection in-progress dialog and performs a wireless LAN connection process. Specifically, using the short-range wireless communication section 113, the digital camera 100 transmits information on a wireless LAN network constructed by a simple AP function, an IP address or identification information of the digital camera 100, and the like to the smartphone 200. Using the short-range wireless communication section 216, the smartphone 200 receives such data necessary for wireless LAN connection from the digital camera 100 and performs a wireless LAN connection process based on the received information. The smartphone 200 makes a connection request to the wireless LAN network constructed by the simple AP function of the digital camera 100. The digital camera 100 confirms authentication information transmitted from the smartphone 200 and establishes a connection to the wireless LAN network of the smartphone 200. Subsequently, the smartphone 200 performs the processes or steps S340 and S341 describes earlier.

In step S330, the camera communication application determines whether or not the user has selected a button 403 representing a wireless LAN connection using Bluetooth on the screen shown is FIG. 4A. When it is determined that the button 403 has been selected, the camera communication application proceeds to step S331.

In step S331, the camera communication application determines whether or not Bluetooth is enabled in the settings of the OS of the smartphone 200. The camera communication application proceeds to step S3321 when it is determined that Bluetooth is disabled but proceeds to step S335 when it is determined that Bluetooth is enabled.

In step S3321, the camera communication application causes the OS to display a Bluetooth setup screen. After causing the OS to display the Bluetooth setup screen, the camera communication application measures elapsed time and determines whether the elapsed time has reached a predetermined period of time (for example, three seconds) (S3322). When the predetermined period of time elapses, a notification screen is displayed (S3323). An example of the screen at this point is shown in FIG. 4H.

The camera communication application determines whether or not to activate the Bluetooth setup screen of the OS based on a selection result of FIG. 4A (whether or not the Bluetooth button 403 has been selected) and a determination result of S331 (whether Bluetooth is enabled or disabled). When the Bluetooth button 403 has been selected in FIG. 4A and Bluetooth is disabled in S331, the camera communication application (the first application) issues an instruction to start a Bluetooth setup function (the second application) of the OS.

In step S333, the camera communication application determines whether or not a tap operation for instructing a return to the camera communication application has been performed on the notification screen 407, and when determining that a tap operation has been performed, the camera communication application proceeds to step S334.

In step S334, an instruction to return to the tutorial screen of the camera communication application from the Bluetooth setup screen of the OS is input to the smartphone 200.

In step S335, a tutorial screen that guides the user through a procedure for Bluetooth paring in accordance with the model selected on the screen shown in FIG. 4B is displayed. In this manner, when an instruction to activate the camera communication application is input on the notification screen 407, a return is made from the Bluetooth setup screen of the OS to the camera communication application.

Moreover, if Bluetooth is not enabled when the user performs a tap operation to instruct a return to the camera communication application in S333, the Bluetooth setup screen shown in FIG. 4H may remain displayed without returning to the camera communication application. In addition, by displaying a message such as “Enable Bluetooth” on the notification screen 407, support may be provided so that the user can reliably execute a procedure to enable Bluetooth. A notification screen is displayed which includes a message generated by the first application (the camera communication application) in accordance with an operation by the user with respect to the second application (the Bluetooth setup screen) or a state of the smartphone 200 (Bluetooth enabled or disabled).

After the user performs the Bluetooth paring operation, in step S336, the smartphone 200 detects a paring request from the digital camera 100 and, after performing paring, performs a connection process in Bluetooth. Moreover, since paring need only be performed once, when paring has already been performed, the smartphone 200 may omit the process of step S335 and proceed to the connection process in Bluetooth in step S336. A detailed description of the processes from Bluetooth paring to connection will be omitted.

Once the connection process in Bluetooth is completed, the smartphone 200 displays a Bluetooth connection completion screen in step S337.

In step S338, the smartphone 200 displays a wireless LAN connection in-progress dialog and performs a wireless LAN connection process. Specifically, using the Bluetooth section 112, the digital camera 100 transmits information on a wireless LAN network constructed by a simple AP function, an IP address or identification information of the digital camera 100, and the like to the smartphone 200. Using the Bluetooth section 215, the smartphone 200 receives such data necessary for wireless LAN connection from the digital camera 100 and performs a wireless LAN connection process based on the received information. The smartphone 200 makes a connection request to the wireless LAN network constructed by the simple AP function of the digital camera 100. The digital camera 100 confirms authentication information transmitted from the smartphone 200 and establishes a connection to the wireless LAN network of the smartphone 200. Subsequently, the smartphone 200 performs the processes of steps S340 and S341 described earlier.

As described above, in the first embodiment, a message that guides the user through settings performed in the second application and a message that guides the user to input an instruction (tap of a notification region) to restore the first application to an active state are displayed on a notification screen (S3123). As an example of the first application, a camera communication application that is an application which guides the user through procedures for connecting an information processing apparatus to a wireless network has been described. As the second application, a wireless LAN setup function, an NFC setup function, and a Bluetooth setup function of an OS that is an application for performing settings related to wireless communication of the information processing apparatus have been described. In addition, when returning to the first application from the second application (S316), a screen (S314) of the first application is displayed to provide guidance on a procedure when receiving an instruction to start the second application in the first application (S3111). Subsequently, a determination is made on whether or not a connection between the information processing apparatus and the wireless network has been established (S315). After the determination, when receiving an instruction to start the second application in the first application (S3111: Yes) a screen of the first application to guide the user through a procedure following the procedure is displayed (S316). The procedure below has been described as the procedure following the procedure when receiving an instruction to start the second application in the first application (S3111). Specifically, a procedure (FIG. 4F) for connecting a second information processing apparatus (the digital camera 100) connected to a wireless network and an information processing apparatus (a smartphone) to each other has been described. In addition, a configuration in which an instruction to activate the first application is input to a notification screen by an operation involving tapping the notification screen (S313) has been described.

Specifically, in the first embodiment, a mechanism for making transitions from a tutorial screen to a setup screen of an OS and from the setup screen of the OS to the tutorial screen is provided. In order to make a transition to the setup screen of the OS, usually, the user must personally open the setup screen of the OS by temporarily closing the tutorial or the like. Conversely, in order to return to the tutorial from the setup screen or the OS, the user must personally return to the tutorial by closing the setup screen of the OS or the like. These are cumbersome operations for a user unfamiliar with operating a smartphone and there is a possibility that the user may become confused as to what should be done on what screen. In this regard, in the first embodiment, since a screen transition from the tutorial to the setup screen of the OS and a screen transition to return from the setup screen of the OS to the tutorial can be performed as a part of the operations of the tutorial, the user can be prevented from becoming confused when performing screen transition operations.

Furthermore, in the case of a simple screen transition from a tutorial screen to a setup screen of the OS, even when an immediately previous tutorial screen describes a setting to be desirably performed by the user on a next screen, there is a possibility that the user may become confused after the screen transition as to what should be done. In this regard, in the first embodiment, messages of the tutorial can be displayed in the notification region even after a transition is made to the setup screen of the OS. Accordingly, the user can perform operations on the setup screen of the OS while referring to messages guiding the user through settings to be performed on the setup screen of the OS, and the user can be supported so that complicated procedures can be reliably executed.

### SECOND EMBODIMENT

Depending on specifications of an OS, display of a notification screen in a notification region may be automatically erased after a certain period of time. Accordingly, there may be cases where the user is unable to read all messages displayed on the notification screen. In addition, when there are messages providing guidance for or instructing a plurality of operations on the notification screen such as shown in FIGS. 4E, 4G, and 4H, there is a possibility that the user cannot perform all guided procedures if the notification screen is erased before the user completes all operations. The second embodiment describes a configuration that enables a user to reliably execute each operation displayed on a notification screen even when a guidance for a plurality of operations or procedures are to be provided by the notification screen.

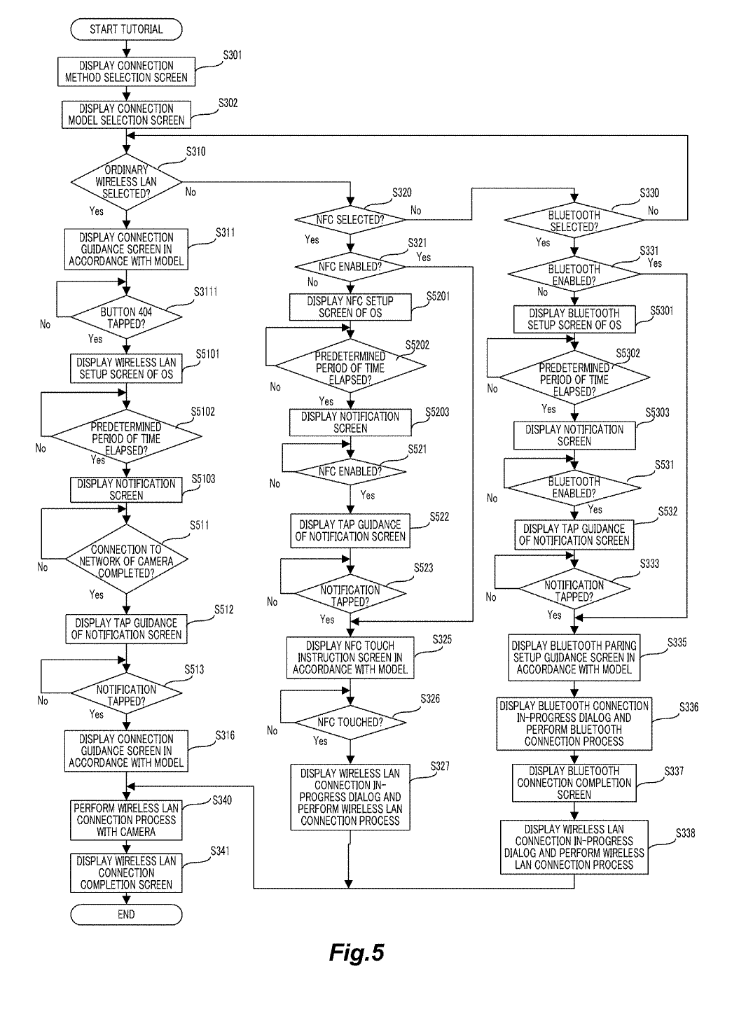

Since the configuration of the digital camera 100 described with reference to FIG. 1 and the configuration of the smartphone 200 described with reference to FIG. 2 are similar to the first embodiment, descriptions thereof will be omitted. In addition, in a flow chart shown in FIG. 5 representing processes by the smartphone 200 according to the second embodiment, steps in which processes with the same contents as those of the flow chart shown in FIG. 3 are performed will be denoted by the same reference characters as FIG. 3 and detailed descriptions thereof will be omitted.

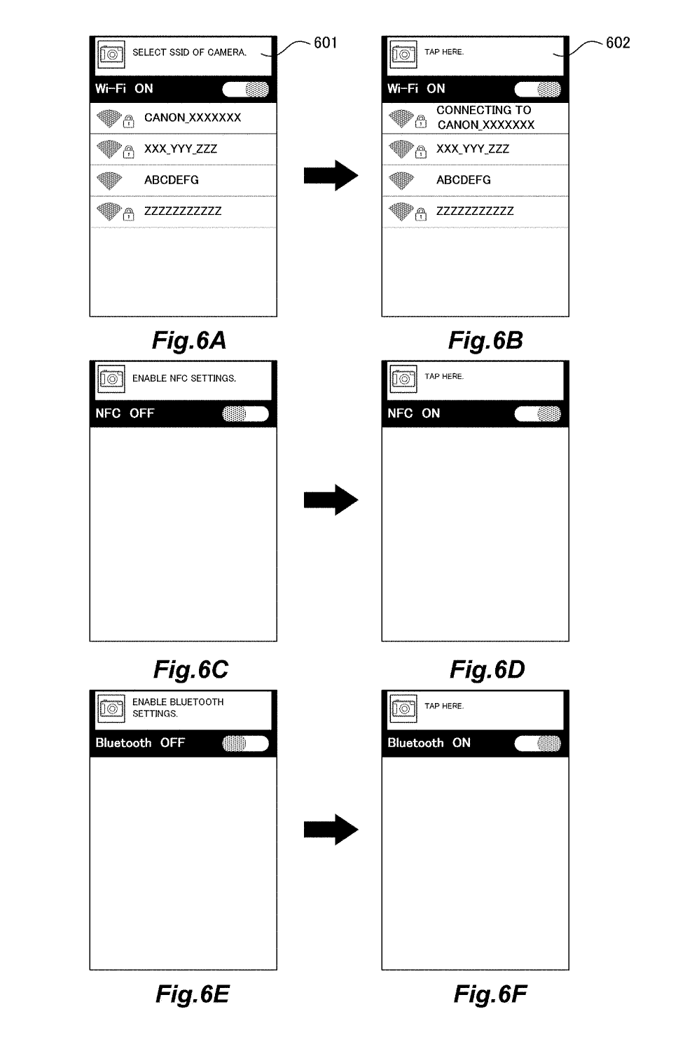

FIG. 5 is a flow chart showing processes of a screen transition in a tutorial according to the second embodiment. In addition, processes of the flow chart shown in FIG. 5 will be described in detail using examples of respective screens in a screen transition of a tutorial shown in FIGS. 6A to 6F. Moreover, the processes described below are realized by the control section 201 of the smartphone 200 by controlling respective sections of the apparatus in accordance with a program stored in the nonvolatile memory 203.

The flow chart shown in FIG. 5 is the flow chart shown in FIG. 3 according to the first embodiment with the exception of changes made from step S3121 to step S315, from step S3221 to step S324, and from step S3321 to step S334.

When the button 401 representing an ordinary wireless LAN connection is selected in FIG. 4A. (S310: Yes) and a determination is made that the button 404 shows in FIG. 4D is pressed (S3111: Yes), the camera communication application proceeds to step S5101.

In step S5101, the camera communication application causes the OS to start the wireless LAN setup function. After causing the OS to display the wireless LAN setup screen, the camera communication application measures elapsed time and determines whether the elapsed time has reached a predetermined period of time (for example, three seconds) (S5102). When the predetermined period of time elapses, a notification screen is displayed (S5103). Specifically, after causing the wireless LAN setup screen to be displayed, the notification screen is displayed after three seconds. Contents displayed on the notification screen at this point are a message which guides the user through an operation to be performed on the wireless LAN setup screen of the OS and which supports a wireless LAN setup by the user. A display example of the notification screen at this point is shown in FIG. 6A.

In step S511, the camera communication application determines whether or not the smartphone 200 has connected to the wireless LAN network constructed by the simple AP function of the digital camera 100. The determination method is similar to that of S315 according to the first embodiment. When it is determined that the connection to the network constructed by the digital camera has been completed, the camera communication application proceeds to step S512. Moreover, when a determination that the connection to the wireless LAN network constructed by the digital camera 100 has been completed cannot be made even after a certain period of time has elapsed, a return may be made to step S510. Accordingly, for example, even when the user is unable to execute a guided procedure on the wireless LAN setup screen of the OS due to a failure to read a message on the notification screen or the like, the user can be supported so that a necessary procedure can be reliably executed. In this manner, the notification screen can also display a message generated by the camera communication application in accordance with a state of the smartphone 200.

In step S512, the camera communication application displays, on the notification screen, a message guiding the user to tap the notification region. A display example of the notification screen at this point is shown in FIG. 6B.

In step S513, the camera communication application determines whether or not the user has tapped the notification screen. When it is determined that the notification screen has been tapped, the camera communication application proceeds to step S316 and a tutorial screen of the camera communication application which guides the user through procedures necessary for wireless LAN connection in accordance with the model is displayed.

Differences between the second embodiment and the first embodiment will now be described. In the first embodiment, a screen transition after tapping the notification (S313: Yes) is a return (S314) to an original screen (S311, FIG. 4D) of the tutorial having been displayed before making a transition to the setup screen of the OS. Subsequently, after it is determined that a connection to the network constructed by the digital camera has been completed (S315: Yes), a transition is made to a screen that provides guidance for a next procedure (S316, FIG. 4F). Therefore, after tapping the notification region and returning to the camera communication application from the wireless LAN setup screen of the OS, the user is to stand by until the tutorial screen makes a transition from FIG. 4D to FIG. 4F. The standby time is a period of time in accordance with the time required by the smartphone 200 to complete connection to the network constructed by the digital camera 100.

On the other hand, in the second embodiment, a determination is made on whether or not the smartphone 200 has completed connection to the network constructed by the digital camera 100 (S511). After the determination, a notification screen for inputting an instruction to return to the camera communication application from the wireless LAN setup screen of the OS to the smartphone 200 is displayed (S512). In addition, the screen transition after tapping the notification (S513: Yes) is not to the original screen (S311, FIG. 4D) but to a screen of a next procedure (S316, FIG. 4F). Therefore, the user is not required to stand by until the tutorial screen makes a transition from FIG. 4D to FIG. 4F as is the case in the first embodiment. As described above, in the second embodiment, when it is determined that a predetermined operation has been performed in the second application, a notification screen for accepting an instruction to activate the first application from the user is displayed. For example, when an operation to select an SSID of the network constructed by the digital camera 100 is performed and a network connection is completed, a notification screen which guides and accepts a tap operation of an instruction to return to the tutorial screen is displayed.

Moreover, in step S510, when a message providing guidance for an operation to be performed by the user on the wireless LAN setup screen of the OS is being displayed on the notification screen, the notification region may be controlled so that nothing happens when the notification region is tapped. Alternatively, the notification region may be controlled so that a return is made to a previous screen (S311) of the tutorial when the notification region is tapped. Accordingly, the user can reconfirm contents of the tutorial before a transition is made to the wireless LAN setup screen of the OS.

In a similar manner, notifications are displayed in two parts in accordance with an operation status of the user with respect to processes from step S5201 to step S523 and from step S5301 to step S533. In steps S5201 and S5301, a setup screen of the OS is displayed, and in a case where a predetermined period of time elapses (Yes in S5202 and S5302), a notification that provides guidance to enable a setting of NFC or Bluetooth is displayed (S5203 and S5303). In steps S521 and S531, a determination is made on whether or not each setting has been enabled. When it is determined that the settings have been enabled, the processing flow respectively proceeds to steps S522 and S532 to notify a message providing guidance to tap the notification region in order to return to the tutorial screen in a similar manner to step S512. Whether or not the user has tapped the notification region in response to this notification is determined in steps S523 and S533, and when it is determined that the notification region has been tapped, the processing flow proceeds to steps S325 and S335. Details of the respective processes are similar to steps S510 to S513. Display examples of the notification screens from step S5201 to step S523 described above are shown in FIGS. 6C and 6D, and display examples of the notification screens from step S5301 to step S533 described above are shown in FIGS. 6E and 6F.

As described above, in the second embodiment, a message that guides the user through settings performed in the second application is first displayed on a notification screen (S510, FIG. 6A). As the second application, a wireless LAN setup function, an NFC setup function, and a Bluetooth setup function of an OS that is an application for performing settings related to wireless communication of the information processing apparatus have been described. Subsequently, after a determination is made that a connection between the information processing apparatus and the wireless network has been established (S511: Yes), a message providing guidance to input an instruction to activate the first application is displayed (S512, FIG. 6B). As an example of the first application, a camera communication application that is an application which guides the user through procedures for connecting an information processing apparatus to a wireless network has been described. In addition, when returning to the first application from the second application (S316), a screen of the first application is displayed to guide the user through a procedure following a procedure when receiving an instruction to start the second application (S3111: Yes). The procedure below has been described as the procedure following the procedure when receiving an instruction to start the second application in the first application (S3111: Yes). Specifically, a procedure (FIG. 4F) for connecting a second information processing apparatus (the digital camera 100) connected to a wireless network and an information processing apparatus (a smartphone) to each other has been described. In addition, a configuration in which an instruction to activate the first application is input to a notification screen by an operation involving tapping the notification screen (S313) has been described. As described above, in the second embodiment, when returning to the first application from the second application, a screen of the first application which differs from the screen when receiving an instruction to start the second application in the first application is displayed.

According to the second embodiment, when guidance on a plurality of procedures is provided by the notification screen, a guidance of each procedure is displayed on the notification screen and, after the procedure is correctly performed, a display of a guidance of a next procedure is notified. As described above, since the user is provided with guidance on one procedure or a small number of procedures at a time and a transition is made to a guidance of a next procedure after waiting for the user to execute the procedure, support can be provided so that the user can more reliably execute each procedure. In addition, even when a display time of a notification display is short due to specifications of the OS or the like, a procedure for which guidance is provided in one notification display can be simplified and the user can be guided in a reliable manner. Furthermore, by repetitively notifying a same message until a procedure is correctly executed, support can be provided so that the user reliably executes each procedure.

As described above, according to the present invention, a user can be supported so that complicated procedures for wirelessly connecting a digital camera and a smartphone to each other can be reliably executed even when the user is not familiar with a setup operation of the digital camera or the smartphone. In particular, since a setup screen of an OS can be displayed as though being a part of a tutorial system and a guidance message in accordance with the situation can also be displayed in a display of the setup screen of the OS, the user can more reliably execute each procedure.

Although preferred embodiments of the present invention have been described above, it is to be understood that the present invention is not limited to such embodiments and various modifications and changes may be within the spirit and scope of the present invention. For example, the present invention has been described in the embodiments presented above using an example of a technique for supporting a user so as to enable the user to reliably execute procedures for connecting a smartphone that is an example of the information processing apparatus according to the present invention to a wireless network constructed by a digital camera having a wireless function. However, the information processing apparatus according to the present invention is not limited to a smartphone and procedures for which support is provided to the user are not limited to procedures for connecting to a wireless network. For example, the information processing apparatus can be applied to any apparatus having a function for accepting an input of an instruction by the user and controlling execution of an application in accordance with the user instruction. Examples of such an apparatus include a game machine, a tablet device, a media player, a smartwatch, a digital TV, and a personal computer (PC).

In the embodiments, a case has been described where the first application according to the present invention, is an application that provides guidance on a procedure for connecting a smartphone to a wireless network constructed by a digital camera and the second application according to the present invention is an application that performs settings related to wireless communication of the smartphone. However, the first application and the second application are not limited to these examples. The present invention is preferably applied to all cases where, in a first application, a result of executing a second application that differs from the first application is to be used. For example, there are cases where, during the use of a web browser, a book viewer application, or the like, a user desires to look up a word in a dictionary. The present invention can be applied by considering the web browser as the first application and a dictionary application that can be started from a pop-up menu which appears when selecting a word on the web browser as the second application. In this case, after a transition is made to the dictionary application and the user looks up a desired word, the user can return to the browser by tapping a notification screen such as that reading “tap to return to browser” displayed superimposed on a part of a display region of the dictionary application.

The object of the present invention can be realized by executing the processing described below. Specifically, the processing involves supplying a storage medium on which is recorded a program code that realizes functions of the embodiments described above to a system or an apparatus and having a computer (or a CPU or an MPU) of the system or the apparatus read the program code stored in the storage medium. In this case, the program code itself having been read from the storage medium is to realize the functions of the embodiments described above, and the program code and the storage medium storing the program code are to constitute the present invention.

In addition, the following can be used as the storage medium for supplying the program code. Examples include a floppy (registered trademark) disk, a hard disk, a magneto-optical disk, a CD-ROM, a CD-R, a CD-RW, a DVD-ROM, a DVD-RAM, a DVD-RW, a DVD+RW, a magnetic tape, a nonvolatile memory card, and a ROM. Alternatively, the program code may be downloaded via a network.

Furthermore, cases where the functions of the embodiments described above are realized when a computer executes a program code having been read are also included in the present invention. In addition, cases where, based on instructions of the program code, an OS (operating system) or the like running on the computer performs a part of or all of the actual processing and the functions of the embodiments described earlier are realized by the processing are also included in the present invention.

In addition, cases where the functions of the embodiments described earlier are realized by the processing below are also included is the present invention. Specifically, a program code read from a storage medium is written into a memory built into an expansion board inserted into a computer or an expansion unit connected to the computer. Subsequently, a CPU or the like built into the expansion board or the expansion unit performs a part or all of the actual processing based on instructions of the program code.

The present invention can also be achieved by supplying a program that realizes one or more functions of the embodiments described above to a system or an apparatus via a network or a storage medium and having one or more processors in a computer in the system or the apparatus read and execute the program. Alternatively, the present invention can also be achieved by a circuit (for example, an ASIC) which realizes one or more functions.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-225097, filed on Nov. 18, 2016, which is hereby incorporated by reference herein in its entirety.

What is claimed is:

1. An information processing apparatus, comprising:
a processor; and
a memory storing a program which, when executed by the processor, causes the information processing apparatus to:
issue, in accordance with an active first application, an instruction to activate a second application;
perform, in response to the instruction to activate the second application, a process of deactivating the first application and a process of activating the second application;
control a display device to display a region for accepting an instruction to activate the first application if a predetermined period of time elapses after the second application becomes active; and
perform, if the instruction to activate the first application is accepted, a process of activating the first application and a process of deactivating the second application.

2. The information processing apparatus according to claim 1, wherein the program when executed by the processor further causes the information processing apparatus to accept an instruction to activate the second application in response to an operation by a user in accordance with the active first application.

3. The information processing apparatus according to claim 1, wherein
the process performed in response to the instruction to activate the second application includes a process of displaying a screen of the second application in a foreground.

4. The information processing apparatus according to claim 1, wherein
the region is controlled so as to be displayed on the display in accordance with the first application.

5. The information processing apparatus according to claim 1, wherein
the process performed in response to the instruction to activate the first application includes a process of displaying, in the foreground, a screen of the first application, which differs from a screen of the first application having been displayed when the instruction to activate the second application had been issued.

6. The information processing apparatus according to claim 5, wherein the program when executed by the processor further causes the information processing apparatus to implement connection with an external device, wherein
the screen of the first application is a screen in accordance with a type of the connected external device.

7. The information processing apparatus according to claim 1, wherein the program when executed by the processor further causes the information processing apparatus to establish communication with an external device in accordance with the active second application; and
if communication is established with the external device, control the display device to display a region for accepting an instruction to activate the first application.

8. A control method of an information processing apparatus, the control method comprising:
issuing, in accordance with an active first application, an instruction to activate a second application;
performing, in response to the instruction to activate the second application, a process of deactivating the first application and a process of activating the second application;
controlling a display device to display a region for accepting an instruction to activate the first application if a predetermined period of time elapses after the second application becomes active; and
performing, if the instruction to activate the first application is accepted, a process of activating the first application and a process of deactivating the second application.

9. A non-transitory computer-readable storage medium in which a program is recorded, the program causing a computer to execute;
issuing, in accordance with an active first application, an instruction to activate a second application;
performing, in response to the instruction to activate the second application, a process of deactivating the first application and a process of activating the second application;
controlling a display device to display a region for accepting an instruction to activate the first application if a predetermined period of time elapses after the second application becomes active; and
performing, if the instruction to activate the first application is accepted, a process of activating the first application and a process of deactivating the second application.
